(19) United States
(12) Patent Application Publication
(10) Pub. No.: US 2018/0042048 A1
(43) Pub. Date: Feb. 8, 2018

(54) SIGNALING OF LISTEN-BEFORE-TALK TYPE FOR UNLICENSED SPECTRUM OPERATION

(71) Applicant: NOKIA SOLUTIONS AND NETWORKS OY, Espoo (FI)

(72) Inventors: Klaus HUGL, Wien (AT); Sigen YE, Whitehouse Station, NJ (US); Claudio ROSA, Randers (DK); Kari Juhani HOOLI, Oulu (FI)

(21) Appl. No.: 15/227,695

(22) Filed: Aug. 3, 2016

(51) Int. Cl. H04W 74/08; H04W 16/14; H04W 72/04

(52) U.S. Cl. CPC H04W 74/0808; H04W 72/0446; H04W 16/14

(57) ABSTRACT

Various communication systems may benefit from signaling that instructs operation of devices. For example, certain wireless communication systems can benefit from signaling of listen-before-talk type for unlicensed spectrum operation. A method can include receiving a mapping between listen before talk type and a set of one or more of downlink ending partial subframe durations. The method can also include receiving indication of at least one downlink ending partial subframe duration of the plurality of downlink ending partial subframe durations. The method can further include determining a listen before talk type based on the received indication and the received mapping. The method can additionally include communicating with at least one access node based on the determined listen before talk type.

### BACKGROUND

### Field

Various communication systems may benefit from signaling that instructs operation of devices. For example, certain wireless communication systems can benefit from signaling of listen-before-talk type for unlicensed spectrum operation.

### Description of the Related Art

Third generation partnership project (3GPP) long term evolution (LTE) release 13 (Rel-13) Licensed Assisted Access (LAA) provides licensed-assisted access to unlicensed spectrum while coexisting with other technologies and fulfilling the regulatory requirements. In Rel-13 LAA, unlicensed spectrum is utilized to improve LTE downlink (DL) throughput. One or more LAA DL secondary cell (SCell) may be configured to a user equipment (UE) as part of DL carrier aggregation (CA) configuration, while the primary cell (PCell) needs to be on licensed spectrum.

In forthcoming versions, uplink (UL) operation is expected to be supported. A listen-before-talk (LBT) mechanism has been defined for UL transmission.

The standardized LTE LAA approach in Rel-13 based on carrier aggregation (CA) framework assumes transmission of Uplink Control Information (UCI) on PCell, for example on licensed band. However, LAA may be expanded with dual connectivity operation, even in standalone LTE operation on unlicensed spectrum. This may allow for non-ideal backhaul between PCell in licensed spectrum and SCell(s) in unlicensed spectrum. In LTE standalone operation on unlicensed spectrum, the evolved Node B (eNB)/User Equipment (UE) air interface may rely solely on unlicensed spectrum without any carrier on licensed spectrum.

Relatedly, the MulteFire Alliance is developing specifications for MulteFire technology which is to be a stand-alone unlicensed band operation in which one requirement is that the MulteFire UL supports sounding reference signal (SRS). Generally the MulteFire Alliance is proceeding by using certain building blocks from LTE LAA, and it is intending to also use building blocks from Rel. 14 eLAA, as much as may be appropriate in order to speed up the development of this LTE technology-based stand-alone operation in the unlicensed bands.

### SUMMARY

According to certain embodiments, a method can include receiving a mapping between listen before talk type and a set of one or more of DL ending partial subframe durations. The method can also include receiving indication of at least one DL ending partial subframe duration of the plurality of DL ending partial subframe durations. The method can further include determining a listen before talk type based on the received indication and the received mapping. The method can additionally include communicating with at least one access node based on the determined listen before talk type.

In certain embodiments, a method can include determining a mapping between a listen before talk type to be applied and a set of one or more of DL ending partial subframe durations. The method can also include signaling the mapping to the user equipment. The method can further include signaling an indication of at least one DL ending partial subframe duration of the plurality of DL ending partial subframe durations. The listen before talk type to be applied can be determined by a user equipment based on receiving the mapping and the indication.

An apparatus, according to certain embodiments, can include at least one processor and at least one memory including computer program code. The at least one memory and the computer program code are configured to, with the at least one processor, cause the apparatus at least to receive a mapping between listen before talk type and a set of one or more of DL ending partial subframe durations. The at least one memory and the computer program code are also configured to, with the at least one processor, cause the apparatus at least to receive indication of at least one DL ending partial subframe duration of the plurality of DL ending partial subframe durations. The at least one memory and the computer program code are further configured to, with the at least one processor, cause the apparatus at least to determine a listen before talk type based on the received indication and the received mapping. The at least one memory and the computer program code are additionally configured to, with the at least one processor, cause the apparatus at least to communicate with at least one access node based on the determined listen before talk type.

An apparatus, in certain embodiments, can include at least one processor and at least one memory including computer program code. The at least one memory and the computer program code are configured to, with the at least one processor, cause the apparatus at least to determine a mapping between a listen before talk type to be applied and a set of one or more of DL ending partial subframe durations. The at least one memory and the computer program code are also configured to, with the at least one processor, cause the apparatus at least to signal the mapping to the user equipment. The at least one memory and the computer program code are further configured to, with the at least one processor, cause the apparatus at least to signal an indication of at least one DL ending partial subframe duration of the plurality of DL ending partial subframe durations. The listen before talk type to be applied can be determined by a user equipment based on receiving the mapping and the indication.

According to certain embodiments, an apparatus can include means for receiving a mapping between listen before talk type and a set of one or more of DL ending partial subframe durations. The apparatus can also include means for receiving indication of at least one DL ending partial subframe duration of the plurality of DL ending partial subframe durations. The apparatus can further include means for determining a listen before talk type based on the received indication and the received mapping. The apparatus can additionally include means for communicating with at least one access node based on the determined listen before talk type.

In certain embodiments, an apparatus can include means for determining a mapping between a listen before talk type to be applied and a set of one or more of DL ending partial subframe durations. The apparatus can also include means for signaling the mapping to the user equipment. The apparatus can further include means for signaling an indication of at least one DL ending partial subframe duration of the plurality of DL ending partial subframe durations. The listen before talk type to be applied can be determined by a user equipment based on receiving the mapping and the indication.

A non-transitory computer-readable medium can, according to certain embodiments, be encoded with instructions that, when executed in hardware, perform a process. The process can include any of the methods mentioned above.

A computer program product can, in certain embodiments, encode instructions for performing a process. The process can include any of the methods mentioned above.

### BRIEF DESCRIPTION OF THE DRAWINGS

For proper understanding of the invention, reference should be made to the accompanying drawings, wherein:

FIG. 1 illustrates a subframe that has sPUCCH following a DL ending partial subframe.

FIG. 2 illustrates a method according to certain embodiments.

FIG. 3 illustrates a system according to certain embodiments.

### DETAILED DESCRIPTION

For UL, there may be a general need for the access node, such as an evolved Node B (eNB), to provide signaling to the UE so that the UE can perform the proper LBT procedure before accessing a channel. Certain embodiments provide a signaling mechanism for LBT type indication for UL transmission on unlicensed spectrum.

In the following discussion, an LBT option is considered possible. However, the same or similar techniques can be applied for LAA enhancements even if no LBT option is supported in LAA. If no LBT is required in some regions, the signaling could be used to indicate that to the UE.

For example, a short Physical Uplink Control Channel (sPUCCH) may be used to carry hybrid automatic repeat request (HARQ) acknowledgment (HARQ-ACK), channel state information (CSI), scheduling request (SR), and/or physical random access channel (PRACH).

In LTE with normal cyclic prefix, one subframe has a duration of 1 ms and consists of 14 orthogonal frequency division multiplexing (OFDM) or single carrier frequency division multiple access (SC-FDMA) symbols. sPUCCH occurs in the last 4 single carrier frequency division multiple access (SC-FDMA) symbols of a subframe, where the first ten symbols are not used for UL transmission. The intention can be that sPUCCH occurs in the same subframe as the DL ending partial subframe, which occurs at the end of a DL transmission burst and occupies only part of a subframe. A DL ending partial subframe can follow a downlink pilot time slot (DwPTS) configuration of a special subframe in frame structure 2 of time division duplex (TDD), which can have a length of {3, 6, 9, 10, 11, 12} SC-FDMA symbols. For sPUCCH to occur in the same subframe as a DL ending partial subframe, the DL ending partial subframe may need to have a length of less than ten symbols, meaning that it can take a length of 3, 6, or 9 symbols. A DL ending partial subframe with 10 symbols followed by sPUCCH may be infeasible, because some DL to UL switching time may be needed at the UE, and timing advance (TA) for UL may also need to be taken into account.

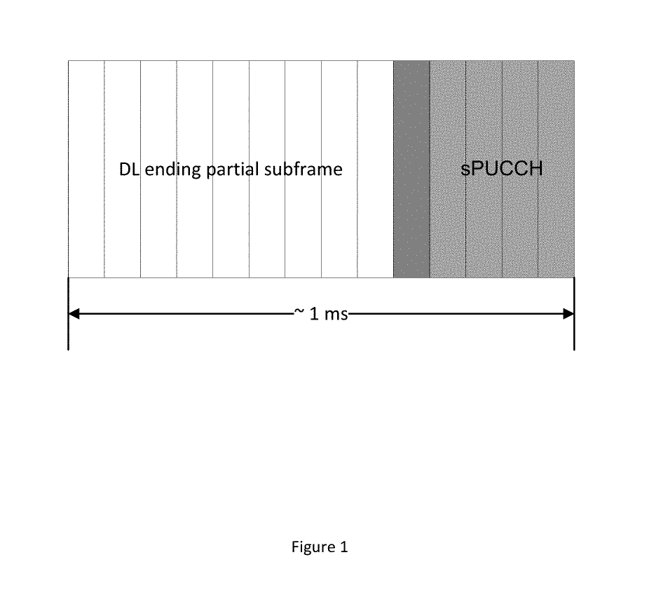

FIG. 1 illustrates a subframe that has sPUCCH following a DL ending partial subframe with 9 symbols. As shown in FIG. 1, a gap may be provided between the nine symbols of DL ending partial subframe and the four symbols of sPUCCH. The gap may be one symbol or may be another length, considering TA. Other configurations are also permitted.

At least two LBT schemes may be supported for sPUCCH in certain implementations of sPUCCH. A first option is that there may be no LBT. Thus, the UE can start sPUCCH transmission without sensing the channel. This may be applicable in, for example, the following cases: when UL transmission starts within 16 μs after the DL transmission ends, or when no LBT is required in general for certain high priority networks in certain unlicensed spectrum frequencies, such as 3.5 GHz spectrum in the US.

A second option is LBT with a predefined sensing window, such as 25 μs LBT. In this example, the UE needs to sense the channel idle within the 25 μs duration before the transmission. This can be applicable when sPUCCH falls with the channel occupancy time acquired by the eNB and the gap between the DL and UL transmission burst is larger than 16 μs and at least 25 μs.

Certain implementations may have the following characteristics, which are provided here as examples. The sPUCCH can carry acknowledgment/negative acknowledgment (A/N), CSI, and/or SR as per eNB configuration. This may allow fast feedback of A/N, CSI, and SR. The physical random access channel (PRACH) on sPUCCH may be 2 or 4 symbols. The presence of dynamic sPUCCH can be signaled by common physical downlink control channel (C-PDCCH) as the last n (for example, 1 to 4) symbols of a subframe where the first 14-n symbols are not used for UL transmission. sPUCCH is 4 symbols. The channel includes 2 DMRS symbols and 2 data symbols. SRS can also be transmitted on sPUCCH and triggered by (e)PDCCH. Such SRS also uses B-IFDMA waveform and is transmitted over the 4 symbols of sPUCCH. UL transmission can start without LBT within 16 μs after the DL transmission ends.

Nevertheless, the UE may need to decide which LBT scheme to use before sPUCCH. Thus, some signaling from the eNB may be necessary. Certain embodiments provide such a signaling scheme.

Two options have been considered for LBT type signaling: in option 1 LBT for sPUCCH (no LBT or single interval LBT) is semi-statically indicated; and in option 2 LBT for sPUCCH is dynamically implicitly indicated via DL ending partial subframe duration. If DL ending partial subframe duration is less than 9 (or 10) symbols, single interval LBT may be needed for sPUCCH transmission. If DL ending partial subframe duration is 9 (or 10) symbols, then sPUCCH transmission can occur without performing LBT. For example, if DL ending partial subframe (sf) duration is either 3 or 6, then single interval LBT can be applied. If DL ending partial sf duration is 9 then sPUCCH transmission can occur without performing LBT. If a 10-symbol DL ending partial subframe is applied, option 2 does not allow any time for DL to UL switching before transmitting sPUCCH, which may make it practically infeasible.

In option 1, the LBT scheme may be fixed once it is configured via higher layer signaling. For networks where no LBT is needed (for example, some higher priority networks in the 3.5 GHz band in the US), such semi-static higher layer signaling to turn off LBT may be sufficient. For frequency bands where LBT is needed, such as if it is needed in the 5 GHz band, this would restrict the dynamic usage of no LBT, when the gap between DL-to-UL is less than 16 us, and 25 μs LBT otherwise.

In option 2, a fixed mapping may be enforced between DL ending partial subframe duration and LBT scheme, which may not always be true depending on the implementation. For example, when the DL ending partial subframe duration is less than 9 symbols, the eNB could provide an additional TA value to all the UEs so that UL transmission occurs earlier and the gap between the DL ending partial subframe transmission and sPUCCH can be reduced to be <=16 μs. By enforcing the 25 μs LBT for DL ending partial subframe duration less than 9 symbols, such an operation would no longer be allowed. Moreover, option 2 if specified would not enable to operate sPUCCH transmission without LBT independent of the DL ending partial subframe duration, such as for high priority networks in unlicensed bands, such as in the 3.5 GHz band in the US.

As both options have such limitations, certain embodiments may provide a signaling scheme that allows more flexibility.

More particularly, certain embodiments apply a joint approach of semi-static signaling and implicit dynamic signaling for LBT type indication. The semi-static signaling/configuration can indicate the LBT type, for example either no LBT or 25 μs LBT, for each DL ending partial subframe duration. The dynamic signaling can indicate the DL ending partial subframe duration, which can be used to derive the LBT type based on the semi-static configuration.

To be more specific, in certain embodiments the semi-static signaling from the eNB can provide the UE a mapping between DL ending partial subframe duration and the LBT type, so that the UE knows whether it should perform no LBT or 25 μs LBT for each DL ending partial subframe duration. When the UE receives the dynamic signaling of DL ending partial subframe duration (which may be carried on the C-PDCCH), it knows the corresponding LBT type based on the configured mapping.

One special case can be when the LBT type corresponding to all the DL ending partial subframe durations is configured as no LBT, which may mean that the UE always performs no LBT. This can be used in cases where, for example, legal regulations do not require LBT.

Another special case can be when the LBT type corresponding to all the DL ending partial subframe durations is configured as 25 μs LBT, which can mean that the UE always performs 25 μs LBT. This can be used when, for example, the eNB does not take any special action to make sure the gap between DL and UL transmission burst is no longer than 16 μs.

In case of sPUCCH, the UE can be provided with ways/rules to determine the presence of sPUCCH, either sharing the same signaling or using different signaling. Any desired technique can be used to accomplish this detection task.

Another implementation, can include the case that even though 25 μs LBT has been configured for a specific DL ending partial subframe duration, the UE is allowed to instead still use no LBT in case the gap between the sPUCCH starting time and DL ending partial subframe ending time is shorter than or equal to 16 μs. The starting time can be based on measured DL timing minus Timing Advance. The ending time can be based on measured DL timing plus DL ending partial subframe duration dynamically signaled on C-PDCCH. This implementation may be useful in cases, such as the described example, where 25 μs LBT would not be possible within the available timeframe of max 16 μs.

Alternatively the implementation can include the case that the mapping between the LBT type and a set of one or more of DL ending partial subframe durations is based partially on the signaled timing advance value so that no LBT is applied with the DL ending partial subframe duration for which the gap between the end of the DL transmission and the start of the UL transmission is equal to or less than 16 μs. Also this implementation may be useful in cases, such as the described example, where 25 μs LBT would not be possible within the available timeframe of max 16 μs.

Although certain embodiments have been described in the context of sPUCCH, similar embodiments can also be used for LBT type indication for any other UL transmission such as PUSCH at the beginning of a UL transmission burst.

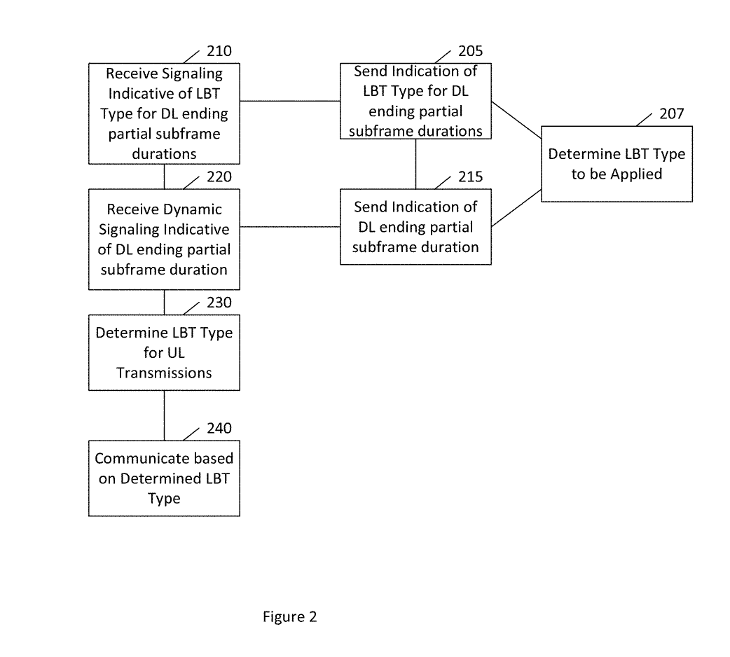

FIG. 2 illustrates a method according to certain embodiments. The method can include, at 210, receiving signaling that indicates the LBT type, such as no LBT or 25 μs LBT, for each of a plurality of applicable DL ending partial subframe durations, such as all possible DL ending partial subframe durations. This signaling can provide a mapping between LBT type and DL ending partial subframe duration.

The indication can be sent, at 205, to the UE using higher layer signaling, such as radio resource control (RRC) configuration. The signaling can be either UE-specific or broadcast.

The method can also include, at 220, receiving a dynamic signaling that indicates the duration of a DL ending partial subframe. The dynamic signaling can be sent at 215.

The method can further include, at 230, determining the LBT type for UL transmissions based on the dynamic indication of DL ending partial subframe duration and the semi-statically configured LBT type signaling.

The determination of the LBT type can disregard the higher layer signaling when the gap between the end of the PDSCH reception and start of the sPUCCH transmission is less than or equal to 16 μs, as discussed above.

The method can also include, at 240, communicating with at least one access node based on the determined listen before talk type. For example, the communicating can involve applying LBT or not based on the indicated DL ending partial subframe duration.

The features at 210, 220, 230, and 240 can be performed by a user equipment, while the features at 205 and 215 can be performed by an access node, such as the access node with which the user equipment is communicating at 240 or another access node.

For example, at 205, the eNB or other access node can transmit signaling to a terminal that indicates the LBT type, such as no LBT as opposed to 25 μs LBT, for all the applicable DL ending partial subframe durations. The configuration can be sent to the UE using higher layer signaling (for example, RRC configuration), which can be either UE-specific or broadcast.

Moreover, at 215, the eNB or other access node can transmit a dynamic signaling that indicates the duration of a DL ending partial subframe. The eNB or other access node can make sure the gap between the DL and UL transmission burst is consistent with the LBT type implied by the dynamic signaling of DL ending partial subframe duration and the semi-statically configured LBT type signaling.

The mapping and indication of DL ending partial subframe duration sent can be based on determination, at 207, of an LBT type to be applied. The timing of this determination can be before sending the mapping or before sending the indication of DL ending partial subframe or at any other desired time. This determination can also be the result of sending the mapping and indication, and that signaling can be based on other considerations.

In case the UE is configured to disregard the higher layer configured LBT type in case the gap is not more than 16 μs, the eNB can have more flexibility in guaranteeing a sufficiently large gap.

The following is an example of a joint signaling scheme. Assuming a DL ending partial subframe of 3, 6, or 9 symbols can co-exist with sPUCCH in the same subframe, the higher layer signaling that defines the mapping between DL ending partial subframe duration and sPUCCH LBT type can be or include a 3-bit bitmap, each bit corresponding to one applicable DL ending partial subframe duration. For example, bit ‘0’ can mean no LBT, and bit ‘1’ can mean 25 μs LBT, for any given DL ending partial subframe duration.

Here are a few examples: ‘110’ can mean no LBT for 9-symbol DL ending partial subframe, and 25 μs LBT for 3- or 6-symbol DL ending partial subframe; ‘000’ can mean no LBT for all the cases; and ‘111’ can mean 25 μs LBT for all the cases.

In another detailed example, the higher layer signaling can include one bit b₀ to differentiate the case without LBT, such as the higher priority network in 3.5 GHz spectrum in the US, and the case where LBT is required when the gap is larger than 16 μs. In case LBT is required, additional bits can be used to indicate which one(s) of the DL ending partial subframe durations corresponds to ‘no LBT’. This may be particularly useful when at most one DL ending partial subframe duration corresponds to ‘no LBT’. Two bits b₁b₂ can be used assuming DL ending partial subframe of 3, 6, or 9 symbols can co-exist with sPUCCH in the same subframe. For example, ‘00’ can mean 25 μs LBT for all DL ending partial subframe durations, ‘01’ can mean no LBT for 3-symbol DL ending partial subframe and 25 μs LBT for all the other DL ending partial subframe durations, ‘10’ can mean no LBT for 6-symbol DL ending partial subframe and 25 μs LBT for all the other DL ending partial subframe durations, ‘11’ can mean no LBT for 9-symbol DL ending partial subframe and 25 μs LBT for all the other DL ending partial subframe durations.

Here are a few examples of how to interpret the signaling: b₀b₁b₂=‘0xx’ can mean no LBT for all cases and ‘x’ can be either 0 or 1; b₀b₁b₂=‘100’ can mean 25 μs LBT for all cases; and b₀b₁b₂=‘111’ can mean no LBT for 9-symbol DL ending partial subframe and 25 μs LBT for all the other DL ending partial subframe durations.

In another detailed example, the higher layer signaling can include a number of bits that indicate the DL ending partial subframe duration(s) for which no LBT should be applied. Here are some non-limiting examples of how to define the meaning of each state: ‘000’ means no LBT for all applicable DL ending partial subframe durations, ‘001’ means no LBT is not used for any of the applicable DL ending partial subframe durations (i.e. 25 μs LBT for all cases), ‘010’ means no LBT for 3-symbol case, ‘011’ means no LBT for 6-symbol case, ‘100’ means no LBT for 9-symbol case. There can be some reserved states that may be used in the future for other purposes.

In another embodiment, when the eNB signals a single value (‘x’) of DL ending partial subframe duration for which no LBT should be applied, the UE can assume no presence of sPUCCH if the dynamically indicated DL ending partial subframe duration is larger than ‘x’. For example, if the eNB signals that no LBT should be applied when the DL ending partial subframe duration is 6 symbols, the UE can assume no sPUCCH in a DL ending partial subframe of 9 symbols. This may be useful when timing advance is semi-statically adjusted to support no LBT for a specific DL ending partial subframe duration, and when any DL ending partial subframe duration larger than this specific one would leave insufficient time for sPUCCH transmission.

The applied Timing Advance (TA) may be a combination of cell-specific Timing Advance value and UE-specific Timing Advance value, or even solely a cell-specific Timing Advance value in small cell deployments.

Biasing TA cell wise, and hence not only due to UE specific propagation delay, may be used to create a gap between DL and UL after UL burst. This way excess time in the subframe containing DL ending partial subframe can be shifted to allow the time for the DL LBT after UL burst. TA offset is already biased in LTE TDD with a constant offset to shift a portion of guard time in LTE TDD Special Subframe for UL-to-DL switching. In certain embodiments, however, additional TA offset can be applied for the purpose of DL LBT.

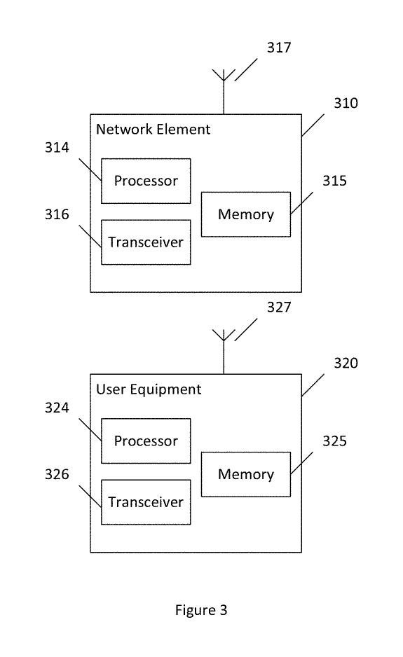

FIG. 3 illustrates a system according to certain embodiments of the invention. It should be understood that each block of the flowchart of FIG. 2 may be implemented by various means or their combinations, such as hardware, software, firmware, one or more processors and/or circuitry. In one embodiment, a system may include several devices, such as, for example, network element 310 and user equipment (UE) or user device 320. The system may include more than one UE 320 and more than one network element 310, although only one of each is shown for the purposes of illustration. A network element can be an access point, a base station, an eNode B (eNB), or any other network element, such as a PCell base station or a SCell base station.

Each of these devices may include at least one processor or control unit or module, respectively indicated as 314 and 324. At least one memory may be provided in each device, and indicated as 315 and 325, respectively. The memory may include computer program instructions or computer code contained therein, for example for carrying out the embodiments described above. One or more transceiver 316 and 326 may be provided, and each device may also include an antenna, respectively illustrated as 317 and 327. Although only one antenna each is shown, many antennas and multiple antenna elements may be provided to each of the devices. Other configurations of these devices, for example, may be provided. For example, network element 310 and UE 320 may be additionally configured for wired communication, in addition to wireless communication, and in such a case antennas 317 and 327 may illustrate any form of communication hardware, without being limited to merely an antenna.

Transceivers 316 and 326 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

A user device or user equipment 320 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof. The user device or user equipment 320 may be a sensor or smart meter, or other device that may usually be configured for a single location.

In an exemplifying embodiment, an apparatus, such as a node or user device, may include means for carrying out embodiments described above in relation to FIG. 2.

Processors 314 and 324 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof.

For firmware or software, the implementation may include modules or units of at least one chip set (e.g., procedures, functions, and so on). Memories 315 and 325 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 310 and/or UE 320, to perform any of the processes described above (see, for example, FIG. 2). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 3 illustrates a system including a network element 310 and a UE 320, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments may have various benefits and/or advantages. For example, certain embodiments may combine the benefits and/or advantages of semi-static signaling and implicit dynamic indication, without having the drawbacks of each of the two methods. For example, certain embodiments may enable overall no LBT or fixed 25 μs LBT type operation. Similarly, certain embodiments may enable LBT type that is dependent on the DL ending partial subframe duration. Moreover, certain embodiments may enable configurable mapping between DL ending partial subframe duration and LBT type, which can provide more flexibility in eNB implementation. Furthermore, certain embodiments can provide an overall flexible signaling framework for LBT type indication.

Certain embodiments involve more signaling overheard through RRC configuration, such as using three bits instead of one bit. This additional overhead may be considered to be minor as it is higher layer signaling.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### LIST OF ABBREVIATIONS

3GPP Third Generation Partnership Project

ACK Acknowledgement

NDI New Data Indicator

CA Carrier Aggregation

CCE Control Channel Element

CSI Channel State Information

DCI Downlink Control Information

DFTS-OFDM Discrete Fourier Transformation Spread Orthogonal Frequency Division Multiplexing

DL Downlink

DM RS Demodulation Reference Signal

DwPTS Downlink Pilot Time Slot

eLAA Enhanced Licensed Assisted Access

eNB Evolved NodeB

ETSI European Telecommunications Standards Institute

FDD Frequency Division Duplex

HARQ Hybrid Automatic Repeat Request

IFDMA Interleaved Frequency Domain Multiple Access

LAA Licensed Assisted Access

LBT Listen-Before-Talk

LTE Long Term Evolution

MCS Modulation and Coding Scheme

OCC Orthogonal Cover Code

OFDM Orthogonal Frequency Domain Multiplexing

PCell Primary cell

PDCCH Physical Downlink Control Channel

PRB Physical Resource Block

PUCCH Physical Uplink Control Channel

sPUCCH Short Physical Uplink Control Channel

PUSCH Physical Uplink Shared Channel

RPF RePetition Factor

RV Redundancy Version

TA Timing Advance

TB Transport Block

TM Transmission Mode

TPC Transmit Power Control

SCell Secondary cell (operating on un-licensed carrier in this IPR)

SRS Sounding reference signals

TA Timing Advance

TDD Time Division Duplex

UCI Uplink Control Information

UE UE Equipment

UL Uplink

We claim:

1. A method, comprising:
receiving a mapping between listen before talk type and a set of one or more downlink ending partial subframe durations;
receiving indication of at least one downlink ending partial subframe duration of the plurality of downlink ending partial subframe durations;
determining a listen before talk type based on the received indication and the received mapping; and
communicating with at least one access node based on the determined listen before talk type.

2. The method of claim 1, wherein the mapping comprises at least one bit or one state that indicates whether listen before talk should be disregarded for all cases.

3. The method of claim 1, wherein the mapping comprises a bitmap that comprises a plurality of bits corresponding to the plurality of downlink ending partial subframe durations which indicate the listen before talk type for each downlink ending partial subframe duration.

4. The method of claim 1, wherein the mapping indicates the set of at least one downlink ending partial subframe duration that does not need listen before talk or indicates that listen before talk is always applied.

5. The method of claim 1, wherein, when the indication comprises a downlink ending partial subframe duration larger than a maximum of the at least one downlink ending partial subframe duration identified with the mapping, the determining further comprises determining that there is to be no short physical uplink control channel transmission.

6. The method of claim 1, wherein the listen before talk type is determined from a set comprising at least no listen before talk and listen before talk having a predetermined duration.

7. The method of claim 6, wherein the predetermined duration comprises 25 microseconds.

8. The method of claim 1, wherein the determination of listen before talk type is based at least partially on at least one received timing advance value so that no listen before talk is applied with downlink ending partial subframe duration for which the gap between the end of the downlink transmission and the start of the uplink transmission is equal to or less than a predetermined duration.

9. A method, comprising:
determining a mapping between a listen before talk type to be applied by a user equipment and a set of one or more downlink ending partial subframe durations;
signaling the mapping to the user equipment; and
signaling an indication of at least one downlink ending partial subframe duration of the plurality of downlink ending partial subframe durations,
wherein the listen before talk type to be applied can be determined by a user equipment based on receiving the mapping and the indication.

10. The method of claim 9, wherein the mapping comprises one bit or state that indicates whether listen before talk should be disregarded for all cases.

11. The method of claim 9, wherein the mapping comprises a bitmap that comprises a plurality of bits corresponding to the plurality of downlink ending partial subframe durations which indicate the listen before talk type for each downlink ending partial subframe duration.

12. The method of claim 9, wherein the mapping indicates the set of at least one downlink ending partial subframe duration that does not need listen before talk or indicates that listen before talk is always applied.

13. The method of claim 9, wherein the listen before talk type is determined from a set comprising at least no listen before talk and listen before talk having a predetermined duration.

14. The method of claim 13, wherein the predetermined duration comprises 25 microseconds.

15. An apparatus, comprising:
at least one processor; and
at least one memory including computer program code,
wherein the at least one memory and the computer program code are configured to, with the at least one processor, cause the apparatus at least to
receive a mapping between listen before talk type and a set of one or more of downlink ending partial subframe durations;
receive indication of at least one downlink ending partial subframe duration of the plurality of downlink ending partial subframe durations;
determine a listen before talk type based on the received indication and the received mapping; and
communicate with at least one access node based on the determined listen before talk type.

16. The apparatus of claim 15, wherein the mapping comprises one bit or one state that indicates whether listen before talk should be disregarded for all cases.

17. The apparatus of claim 15, wherein the mapping comprises a bitmap that comprises a plurality of bits corresponding to the plurality of downlink ending partial subframe durations which indicate the listen before talk type for each downlink ending partial subframe duration.

18. The apparatus of claim 15, wherein the mapping indicates the set of at least one downlink ending partial subframe duration that does not need listen before talk or indicates that listen before talk is always applied.

19. The apparatus of claim 15, wherein the listen before talk type is determined from a set comprising at least no listen before talk and listen before talk having a predetermined duration.

20. An apparatus, comprising:
at least one processor; and
at least one memory including computer program code,
wherein the at least one memory and the computer program code are configured to, with the at least one processor, cause the apparatus at least to
determine a mapping between a listen before talk type to be applied by a user equipment and a set of one or more downlink ending partial subframe durations;
signal the mapping to the user equipment; and
signal an indication of at least one downlink ending partial subframe duration of the plurality of downlink ending partial subframe durations,
wherein the listen before talk type to be applied can be determined by a user equipment based on receiving the mapping and the indication.

21. The apparatus of claim 20, wherein the mapping comprises one bit or state that indicates whether listen before talk should be disregarded for all cases.

22. The apparatus of claim 20, wherein the mapping indicates the set of at least one downlink ending partial subframe duration that does not need listen before talk or indicates that listen before talk is always applied.

23. The apparatus of claim 20, wherein the mapping comprises a bitmap that comprises a plurality of bits corresponding to the plurality of downlink ending partial subframe durations which indicate the listen before talk type for each downlink ending partial subframe duration.
